(19) United States
(12) Patent Application Publication
(10) Pub. No.: US 2008/0253580 A1
(43) Pub. Date: Oct. 16, 2008

(54) EQUIPMENT FOR PROGRAMMING A HEARING AID AND AHEARING AID

(75) Inventors: Svend Vitting ANDERSEN, Espergarde (DK); Lars Baekgaard Jensen, Farum (DK); Morten Kroman, Taastrup (DK)

Correspondence Address: SUGHRUE MION, PLLC, 2100 PENNSYLVANIA AVENUE, N.W., SUITE 800, WASHINGTON, DC, 20037, US

(73) Assignee: Widex A/S, Varlose (DK)

(21) Appl. No.: 12/105,077

(22) Filed: Apr. 17, 2008

Related U.S. Application Data
(63) Continuation-in-part of application No. PCT/DK2006/000536, filed on Sep. 29, 2006.

(30) Foreign Application Priority Data
Oct. 18, 2005 (DK) PA200501457
Mar. 31, 2006 (DK) PA200600462

(51) Int. Cl. H04R 29/00

(52) U.S. Cl. 381/60

(57) ABSTRACT

A programming equipment (1) for programming (fitting) of a programmable hearing aid (2) comprises means for receiving information on the state of operation of signal processing systems included in the hearing aid. This information is utilized to present a graphical representation of the state of operation of these systems to the person performing the programming. The invention further provides a hearing aid and a method of programming a hearing aid.

### RELATED APPLICATIONS

The present application is a continuation-in-part of application No. PCT/DK2006/000536; filed on 29 Sep. 2006, in Denmark and published as WO 2007045240, the contents of which are incorporated hereinto by reference.

### BACKGROUND OF THE INVENTION

1. Field of the Invention

The present invention relates to programming equipment for the programming of a hearing aid. Such equipment is commonly known as a fitting equipment or fitting system. More specifically, the invention relates to such a system wherein information on the momentary actions of the hearing aid is transmitted to the fitting system. In addition, the present invention relates to a hearing aid adapted for interaction with such a system and a method of programming such a hearing aid.

2. The Prior Art

Modern hearing aids often include one or more highly complex signal processing systems. Examples on such signal processing systems are directional input systems, feedback cancellation systems and transposing systems. The person responsible for the adaptation of such a hearing aid to the individual user, commonly known as the fitter, faces a difficult task, since a lot of different parameters are to be coded into the hearing aid for this adaptation. This difficulty is enhanced by the fact that some of the signal processing systems applied in high-end hearing aids adapt their operation over time. Especially, during fitting to situations that the user find problematic, the fitter may be concerned that one or more of the complex signal processing systems change their state of operation during this stage of the fitting procedure and will want a way of verifying the current state of operation, in order to guide the fitter to those settings that will have an impact in the current situation.

Accordingly, there is a need for a fitting system where information on the state of operation of the hearing aid can be presented graphically to the person responsible for the fitting procedure.

### SUMMARY OF THE INVENTION

The invention, in a first aspect, provides a programming equipment for the programming of a hearing aid, the hearing aid having at least a first signal processing system adapted for changing a state of operation over time, the programming equipment comprising means for reading data from the hearing aid, and means for deriving at least a first parameter representing a current state of operation of said signal processing system, means for calculating, on the basis of said first parameter, a model of said signal processing system, and means for displaying a graphical representation of the current state of operation of said signal processing system.

By providing this programming equipment, a graphical representation on the state of operation of at least one signal processing system, included in the hearing aid, may be presented to the fitter.

According to an embodiment, the hearing aid is adapted for transmitting such information to the fitting equipment.

The invention, in a second aspect, provides a hearing aid adapted for being programmed by a programming equipment, and having at least a first signal processing system adapted for changing a state of operation over time, said equipment being adapted for reading data from the hearing aid, said hearing aid being adapted for generating information on the current state of operation of said first signal processing system, in order to enable said equipment to receive the information and display a graphical representation of the current state of operation of said first signal processing system.

The invention in a third aspect, provides a method of programming a hearing aid, said hearing aid being adapted for changing a state of operation over time, the method comprising the steps of reading data from the hearing aid, coding parameters to the hearing aid, deriving information on the current state of operation of at least a first signal processing system included in the hearing aid, calculating, on the basis of the derived information, models for the current state of operation of said first signal processing system, and presenting a graphical representation of this model to the user of the programming equipment.

According to a preferred embodiment of the invention, the information presented graphically to the fitter relates to the operation of a directional system. In this way, information on which signal sources are attenuated by the directional system is available to the fitter.

According to another preferred embodiment of the invention, the information presented graphically to the fitter relates to the operation of a feedback cancellation system. In this way, information on which signal components are attenuated by the cancellation system is available to the fitter.

According to yet another preferred embodiment of the invention, the information presented graphically to the fitter relates to the operation of a transposing system. In this way, information on which signal components are added to other signal components by the transposing system is available to the fitter.

### BRIEF DESCRIPTION OF THE DRAWINGS

The invention will now be described in greater detail based on non-limiting examples of preferred embodiments and with reference to the appended drawings. In the drawings,

FIG. 1 illustrates a programmable hearing aid connected to programming equipment,

FIG. 2 illustrates a graphical representation of the state of operation of a directional system,

FIG. 3 illustrates a graphical representation of the state of operation of a feedback cancellation system,

FIG. 4 illustrates a graphical representation of the state of operation of a transposing system, and

FIG. 5 illustrates a graphical representation of the state of operation of a compressor/expander system.

### DETAILED DESCRIPTION OF THE INVENTION

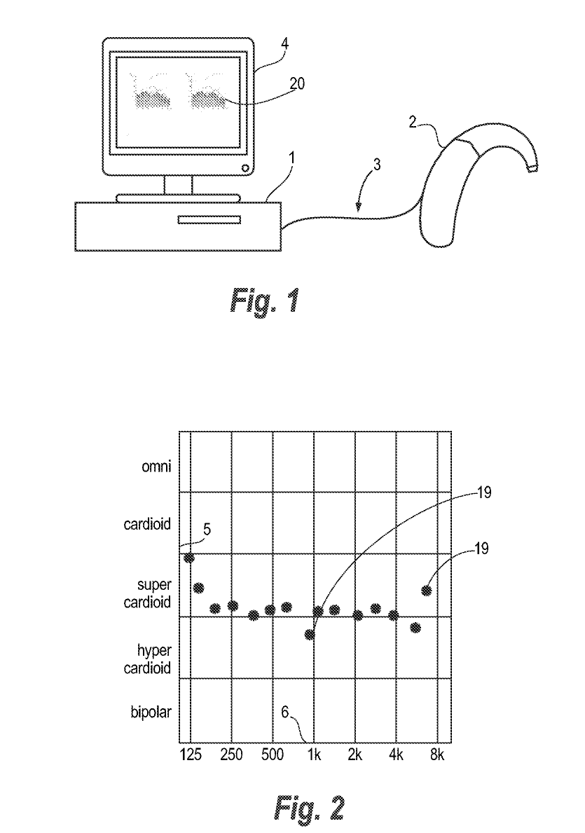

FIG. 1 shows a commonly known programming equipment, also known as a fitting equipment, in the form of a personal computer PC 1 adapted to the purpose. Also shown is a hearing aid 2 connected to the fitting equipment by a wired connection 3. It is well known to the skilled person that such a connection may be either wired (as shown), or wireless (not shown). Preferably, the hearing aid is mounted on the user in the ordinary position for use (not shown). The fitting equipment comprises software for reading data from the hearing aid, presenting information to the operator about the hearing aid and about the user, receiving operator input and coding parameters to the hearing aid in order to program settings controlling the operation of the hearing aid. Programming equipment per se is known from e.g. U.S. Pat. No. 4,901,353 and U.S. Pat. No. 4,989,251 (EP 341997 and EP 341903).

According to the invention, a graphical representation 20 of the state of operation of one or more signal processing systems, is presented to the fitter on the monitor 4.

As shown on FIG. 2, this information may relate to a directional system. It is known, e.g. from US 2004/0081327 A1, that a hearing aid may utilize a number of so-called directional controllers, each operating adaptively in its own frequency band. In the example of FIG. 2 there are 15 frequency bands, but the skilled person will know that the number of frequency bands is merely a choice in the design of the hearing aid. By using a directional controller, e.g. of the kind known from WO 01/01731 A1, a single parameter representing the shape of the directional characteristic—in each band—may be used to calculate a model of the full directional system. WO-A-2005/029914, incorporated herein by reference, describes how a single parameter, determines the directional characteristics of the hearing aid. Preferably, this parameter is transmitted to the programming equipment via the connection 3. Transmission of such parameters is as such well known, and the skilled person will know to use an appropriate protocol such as the Digital Screwdriver (DSD) protocol developed by Etymotic Research Inc., which inter alia allows register values to be read from a hearing aid. Also, such transmission is disclosed in U.S. Pat. No. 4,989,251, also incorporated herein by reference.

The model currently in use may then be presented graphically by mapping these parameters 5 against the frequency values 6. Such a mapping could be by names as indicated in FIG. 2, by the names, “omni”, “cardioid”, “supercardioid”, “hypercardioid”, “bipolar”, along the ordinate. Moreover, in addition to the mapping by names of the parameters 5 against frequency values 6, the markers 19 used preferably also convey information to the fitter. In particular by changing their shape, corresponding the mapping, i.e. by having the shape of a circular dot when the mapping is at “omni” and a shape recognizable as a cardioid when the mapping is at “cardioid”, etc.

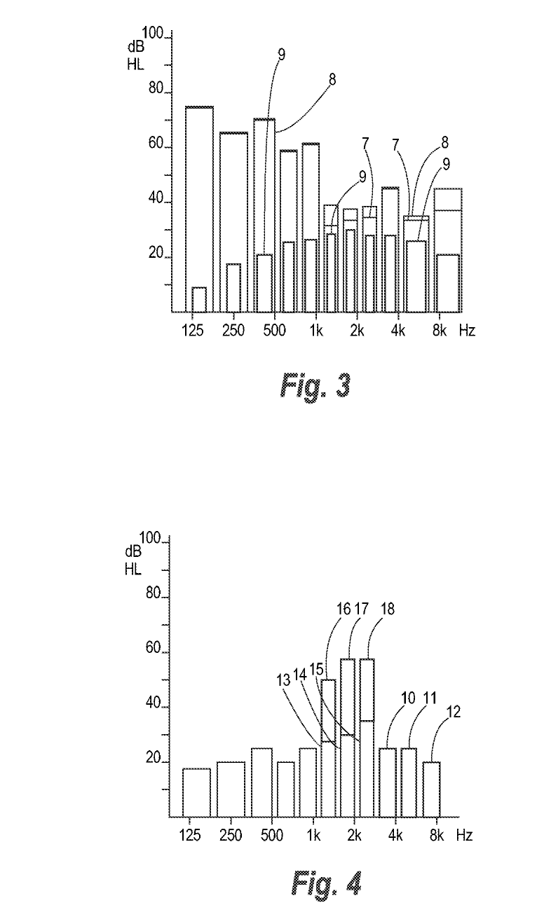

As shown on FIG. 3, this information may also relate to a feedback cancelling system. It is known, e.g. from US 2004/013557 A1, that it is possible to calculate the loop-gain, i.e. the threshold at which feedback oscillation in an uncompensated system will occur. It is also known, e.g. from EP-A-1191813, to estimate the increase in the gain-margin due to the compensation system (the cancellation system). Accordingly, a good representation of the state of operation of the feedback cancellation may include, for each band, a representation of loop-gain 7, a maximum available gain 8, which is the loop-gain 7 plus the gain-margin and is referred to as “supergain”, and momentary signal level 9. For the graphich representation it is thus sufficient, for each channel to transmit values for the two parameters, loop-gain and gain-margin, from the hearing aid 2 to the fitting equipment.

It should be noted that, in order to illustrate that the number of frequency bands represented in the graphic display is merely a matter of design in the hearing aid 2 to be fitted, both FIG. 3 and FIG. 4 use representations with eleven frequency bands. As shown in FIG. 4, this information may also relate to a transposing system. It is known in the art, that such a system may be useful e.g. for treatment of severe high-frequency hearing loss. According to this technology, signal components in frequency bands with severe loss may be translated (also called transposed) to other frequency bands where the hearing loss is less severe. By the hearing aid sending information to the programming equipment about which channels are currently being transposed the transposed parts may be indicated in a way making them distinguishable from the normal signal of those bands. Accordingly, a good representation of such a system will show the mapping of signal components from bands with severe loss 10-12 onto bands with less severe loss 13-15 with an indication 16-18 of the amount of amplification applied to these signal components.

In this case the parameters to be transmitted from the hearing aid 2 to the fitting equipment would be which bands are to be shifted to which bands, and with what weight. If all of the transposed bands are to be shifted, three bands down, as in the illustrated example, a single parameter would suffice for them all, similarly a single parameter would suffice if they are all to be given the same weight after being transposed.

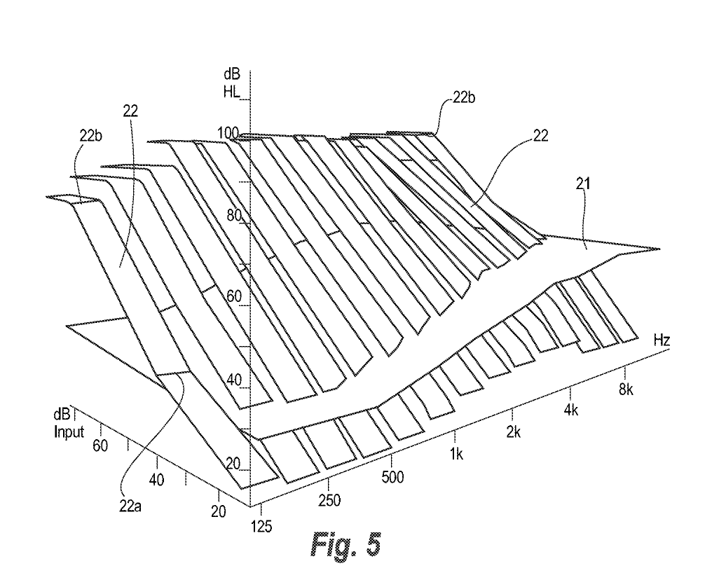

FIG. 5 illustrates a graphical 3D representation of the operation of a compressor/expander system of a hearing aid.

The representation has three axes. Along the abscissa is the frequency, along the ordinate is the input level to the hearing aid, and along the vertical third axis is the output level from the hearing aid.

The graphical 3D representation includes a surface 21 indicating the hearing threshold for a given hearing aid user. Intersecting the surface 21 there is a number, thirteen, of gain curves 22 for specific frequency bands of the hearing aid. The inclination of the gain curves 22 indicate different degrees of compression and/or expansion, including of cause neutral level-independent gain as well as an upper gain limit.

The parameters which are transmitted from the hearing aid 2 to the programming equipment, could be the knee points 22a, 22b and the compression or expansion ration on either side of the knee points. Thus, taking as an example the gain in the band around 125 Hz, the parameters transmitted would be the location of the knee points 22a and 22b in terms of input level. The degree of expansion below knee point 22a, between the knee points 22a and 22b, and the degree of expansion above the knee point 22b. In the example the term expansion is not to be taken literally, as below the knee point 22a there is in fact a compression, i.e. an expansion less than one. Between the knee points 22a and 22b the expansion is neutral b, and above the knee point 22b the expansion is in fact limiting.

Even though the description of the embodiments above has included the derivation, in the hearing aid, of the information on the state of operation of the relevant signal processing systems, it is within the scope of the invention to maintain, in the programming equipment, a model of the relevant signal processing systems, and to derive the relevant parameters, required to establish the graphical representation, from this model. However, this is a less preferred embodiment, since this does not enable the fitter to detect any malfunction in the relevant systems.

Apart from the above-mentioned information, sent from the hearing aid 2 to the fitting equipment, for aiding the fitter in understanding the actions of the hearing aid, other information could be sent. The skilled person will understand that information regarding other components of the hearing aid 2 could be sent. These could inter alia relate to compression functions, gain in specific frequency bands etc. The latter could occur in connection with noise suppression or speech enhancement, in which the specific frequency bands are shaped e.g. in terms of gain.

We claim:

1. A programming equipment for the programming of a hearing aid, the hearing aid having at least a first signal processing system adapted for changing a state of operation over time, the programming equipment comprising means for reading data from the hearing aid, and means for deriving at least a first parameter representing a current state of operation of said signal processing system, means for calculating, on the basis of said first parameter, a model of said signal processing system, and means for displaying a graphical representation of the current state of operation of said signal processing system.

2. The programming equipment according to claim 1, wherein the hearing aid has a second signal processing system adapted for changing a state of operation over time, and wherein said programming equipment has means for deriving a second parameter representing a current state of operation of the hearing aid.

3. The programming equipment according to claim 1, wherein said first signal processing system is selected from the group consisting of a directional system, a feedback cancellation system, a transposing system and a compressor system.

4. The programming equipment according to claim 1, wherein the graphical representation relates to a directional system.

5. The programming equipment according to claim 4, wherein the graphical representation includes mapping parameters by markers against frequency values, the markers being selected from the group consisting of “omni”, “cardioid”, “supercardioid”, “hypercardioid”, and “bipolar”.

6. The programming equipment according to claim 1, wherein the graphical representation relates to a feedback cancellation system.

7. The programming equipment according to claim 6, wherein the graphical representation includes mapping at least one of loop-gain and gain margin against frequency values.

8. The programming equipment according to claim 1, wherein the graphical representation relates to a transposing system.

9. The programming equipment according to claim 8, wherein the graphical representation indicates which frequency channels are currently being transposed, with an indication of the amount of amplification applied to these signal components.

10. The programming equipment according to claim 1, wherein the graphical representation relates to a compressor system.

11. The programming equipment according to claim 10, wherein the graphical representation includes mapping against frequency values of knee-points and degrees of compression or expansion.

12. A hearing aid adapted for being programmed by a programming equipment, and having at least a first signal processing system adapted for changing a state of operation over time, said equipment being adapted for reading data from the hearing aid, said hearing aid being adapted for generating information on the current state of operation of said first signal processing system, in order to enable said equipment to receive the information and display a graphical representation of the current state of operation of said first signal processing system.

13. A method of programming a hearing aid, said hearing aid being adapted for changing a state of operation over time, the method comprising the steps of reading data from the hearing aid, coding parameters to the hearing aid, deriving information on the current state of operation of at least a first signal processing system included in the hearing aid, calculating, on the basis of the derived information, models for the current state of operation of said first signal processing system, and presenting a graphical representation of this model to the user of the programming equipment.

14. The method according to claim 13, comprising the step of receiving, from the hearing aid, information on the current state of operation of said first signal processing systems.
